(19) United States
(12) Patent Application Publication
(10) Pub. No.: US 2019/0244772 A1
(43) Pub. Date: Aug. 8, 2019

(54) KEYBOARD DEVICE

(71) Applicant: Primax Electronics Ltd., Taipei (TW)

(72) Inventor: Yi-Chen Wang, Taipei (TW)

(21) Appl. No.: 16/190,005

(22) Filed: Nov. 13, 2018

(30) Foreign Application Priority Data
Feb. 2, 2018 (TW) 107103862

(51) Int. Cl. H01H 13/7065; G06F 1/16; H01H 13/86

(52) U.S. Cl. CPC H01H 13/7065; G06F 1/1618; H01H 13/86; H01H 2239/03; H01H 2223/04; H01H 2223/05; H01H 2221/068

(57) ABSTRACT

A keyboard device includes a supporting plate, a keycap, a stopping structure and a switching module. The stopping structure is arranged between the supporting plate and the keycap, and located near an outer edge of the keycap. The switching module is located under the keycap and connected with the stopping structure. While the switching module is moved relative to the supporting plate in a second axial direction, the stopping structure is correspondingly moved. When the switching module is in a first status, the stopping structure is located near the outer edge of the keycap. When the switching module is in a second status, the stopping structure is moved to a position under the first outer edge of the keycap to stop the movement of the keycap.

### FIELD OF THE INVENTION

The present invention relates to a keyboard device, and more particularly to a keyboard device having a function of avoiding erroneous operations.

### BACKGROUND OF THE INVENTION

Generally, the widely-used peripheral input device of a computer system includes for example a mouse device, a keyboard device, a trackball, or the like. Via the keyboard device, characters or symbols can be directly inputted into the computer system. As a consequence, most users and most manufacturers of input devices pay much attention to the development of keyboard devices. As known, a keyboard device with scissors-type connecting elements is one of the widely-used keyboards.

FIG. 1 is a schematic perspective view illustrating the structure of a conventional notebook computer. As shown in FIG. 1, the conventional notebook computer 1 comprises a keyboard base 10, a top cover 11, a rotary shaft 12 and a keyboard device 13. The top cover 11 comprises a display screen 111. The top cover 11 is rotatable through the rotary shaft 12. Consequently, the top cover 11 is closed to cover the keyboard base 10, or the top cover 11 is uplifted to allow the notebook computer 1 to be in a usage status. The keyboard device 13 is installed on the keyboard base 10. When the keyboard device 13 is operated by the user, a corresponding key signal is generated. Meanwhile, the notebook computer 1 is in a laptop mode. Moreover, the keyboard device 13 comprises plural key structures 130.

The key structure 130 of the keyboard device 13 will be illustrated as follows. For succinctness, only one key structure 130 of the keyboard device 13 is shown. FIG. 2 is a schematic side cross-sectional view illustrating a key structure of a conventional keyboard. As shown in FIG. 2, the conventional key structure 130 of the keyboard device 13 comprises a keycap 1301, a scissors-type connecting element 1302, a rubbery elastomer 1303, a membrane switch circuit member 1304 and a supporting plate 1305. The keycap 1301, the scissors-type connecting element 1302, the rubbery elastomer 1303 and the membrane switch circuit member 1304 are supported by the supporting plate 1305. The scissors-type connecting element 1302 is used for connecting the supporting plate 1305 and the keycap 1301.

The scissors-type connecting element 1302 is arranged between the supporting plate 1305 and the keycap 1301, and the supporting plate 1305 and the keycap 1301 are connected with each other through the scissors-type connecting element 1302. The rubbery elastomer 1303 is enclosed by the scissors-type connecting element 1302. The membrane switch circuit member 1304 comprises plural key intersections (not shown). When one of the plural key intersections is triggered, a corresponding key signal is generated.

The rubbery elastomer 1303 is disposed on the membrane switch circuit member 1304. Each rubbery elastomer 1303 is aligned with a corresponding key intersection. When the rubbery elastomer 1303 is depressed, the rubbery elastomer 1303 is subjected to deformation to push the corresponding key intersection of the membrane switch circuit member 1304. Consequently, the corresponding key signal is generated.

The operations of the conventional key structure 130 in response to the depressing action of the user will be illustrated as follows. Please refer to FIG. 2 again. While the keycap 1301 is depressed, the keycap 1301 is moved downwardly to push the scissors-type connecting element 1302 in response to the depressing force. As the keycap 1301 is moved downwardly relative to the supporting plate 1305, the keycap 1301 pushes the corresponding rubbery elastomer 1303. At the same time, the rubbery elastomer 1303 is subjected to deformation to push the membrane switch circuit member 1304 and trigger the corresponding key intersection of the membrane switch circuit member 1304. Consequently, the membrane switch circuit member 1304 generates a corresponding key signal. When the keycap 1301 is no longer depressed by the user, no external force is applied to the keycap 1301 and the rubbery elastomer 1303 is no longer pushed by the keycap 1301. In response to the elasticity of the rubbery elastomer 1303, the rubbery elastomer 1303 is restored to its original shape to provide an upward elastic restoring force. In response to the elastic restoring force, the keycap 1301 is returned to its original position where it is not depressed.

Recently, a touch device is introduced into the market. The touch device is operated by using the user's finger directly or using a touch pen. Since the touch device is easy to use, many users and many manufacturers pay much attention to the touch device. For example, the display screen 111 of the notebook computer 1 is a touch screen with a touch control function. Moreover, a notebook computer having an inversely foldable screen is introduced into the market. FIG. 3 is a schematic perspective view illustrating a conventional notebook computer having an inversely foldable screen, in which the notebook computer is in a tablet mode. After the top cover 11 of the notebook computer 1 is rotated in the direction toward a rear side of the keyboard base 10 through the rotary shaft 12, the top cover 11 is folded to be contacted with a rear surface of the keyboard base 10 and the display screen 111 is exposed. Meanwhile, the notebook computer 1 has the outer appearance of a touch device such as a tablet computer. Since the display screen 111 is a touch screen, the notebook computer 1 can be used as a touch device.

However, the keyboard device 13 of the notebook computer 1 in the tablet mode is also exposed. Consequently, when the notebook computer 1 is held by the user's hands, the fingers of the user may press the key structures 130. Since the pressed key structures 130 are moved downwardly to form a concave region, it is difficult for the user to stably hold the notebook computer 1. Moreover, if the key structure 130 is erroneously triggered when the notebook computer 1 is held by the user's hands, the notebook computer 1 also generates a key signal. Under this circumstance, the erroneous operation is generated. In other words, the conventional keyboard device is not user-friendly.

Therefore, there is a need of providing a keyboard device capable of avoiding erroneous operations in response to the changed appearance.

### SUMMARY OF THE INVENTION

The present invention provides a keyboard device having a function of avoiding erroneous operations.

In accordance with an aspect of the present invention, there is provided a keyboard device. The keyboard device includes a supporting plate, a keycap, a first stopping structure and a switching module. The keycap is located over the supporting plate, and movable relative to the supporting plate in a first axial direction. The first stopping structure is arranged between the supporting plate and the keycap, and located near a first outer edge of the keycap. The switching module is located under the keycap and connected with the first stopping structure. While the switching module is moved relative to the supporting plate in a second axial direction, the first stopping structure is correspondingly moved. When the switching module is in a first status, the first stopping structure is located near the first outer edge of the keycap. When the switching module is in a second status, the first stopping structure is moved to a position under the first outer edge of the keycap, so that the keycap is not allowed to be moved in the first axial direction.

In an embodiment, the switching module includes a movable plate and a protrusion post. The movable plate is located under the supporting plate, and movable relative to the supporting plate in the second axial direction. The movable plate includes a sliding track. The protrusion post is inserted into the sliding track. When the protrusion post is pushed by the movable plate, the first stopping structure is correspondingly moved relative to the supporting plate in a third axial direction. When the switching module is in the first status, the protrusion post is located at a first position of the sliding track and the keycap is moved relative to the supporting plate in the first axial direction in response to a depressing action. When the switching module is in the second status, the movable plate is moved to push the protrusion post, so that the protrusion post is moved to a second position of the sliding track. When the protrusion post is moved to the second position of the sliding track, the first stopping structure is correspondingly moved to a position under the first outer edge of the keycap and the keycap is not allowed to be moved in the first axial direction.

In an embodiment, the keyboard further includes a second stopping structure. The second stopping structure is arranged between the supporting plate and the keycap, and located near a second outer edge of the keycap. The switching module includes a first movable plate, a second movable plate and a gear. The first movable plate is arranged beside a first side of the keycap and connected with the first stopping structure. The first movable plate is movable relative to the supporting plate in the second axial direction. The first movable plate includes a first rack. The second movable plate is arranged beside a second side of the keycap and connected with the second stopping structure. The second movable plate is movable relative to the supporting plate in the second axial direction. The second movable plate includes a second rack. The gear is arranged between the first movable plate and the second movable plate, and engaged with the first rack and the second rack.

When the switching module is in the first status, the first movable plate is located at a first position, the second movable plate is located at a second position, and the keycap is movable relative to the supporting plate in the first axial direction in response to the depressing action. When the first movable plate is moved to a third position and the second movable plate is moved to a fourth position, the first stopping structure is moved with the first movable plate and moved to a position under the first outer edge of the keycap, and the second stopping structure is moved with the second movable plate and moved to a position under the second outer edge of the keycap, so that the keycap is not allowed to be moved in the first axial direction.

From the above descriptions, the present invention provides the keyboard device. As the movable plate of the switching module is moved, the stopping structures are correspondingly moved. Consequently, the keycaps are selectively in a depressible mode or a non-depressible mode. When the notebook computer is in the tablet mode, even if the keycap is carelessly touched, the problem of causing erroneous operation is avoided. In a preferred embodiment, the function of the membrane switch circuit member is disabled through a software control method when the notebook computer is in the tablet mode. Since the membrane switch circuit member is not triggered, the possibility of causing the erroneous operation is further avoided. In comparison with the conventional technologies, the keyboard device of the present invention has simpler structure and is easily operated. Consequently, the keyboard device of the present invention can solve the drawbacks of the conventional technologies.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the structure of a conventional notebook computer;

FIG. 2 is a schematic side cross-sectional view illustrating a key structure of a conventional keyboard;

FIG. 3 is a schematic perspective view illustrating a conventional notebook computer having an inversely foldable screen, in which the notebook computer is in a tablet mode;

FIG. 4 is a schematic side cross-sectional view illustrating a notebook computer with a keyboard device according to a first embodiment of the present invention;

FIG. 5 is a schematic exploded view illustrating the keyboard device according to the first embodiment of the present invention and taken along a first viewpoint;

FIG. 6 is a schematic exploded view illustrating the keyboard device according to the first embodiment of the present invention and taken along a second viewpoint;

FIG. 7 is a schematic view illustrating the protrusion posts and the stopping structures of a keyboard device according to a second embodiment of the present invention;

FIG. 8 is a schematic top view illustrating a portion of the switching module of the keyboard device according to the first embodiment of the present invention, in which the switching module is in a first status;

FIG. 9 is a schematic side cross-sectional view illustrating the notebook computer with the keyboard device according to the first embodiment of the present invention, in which the appearance of the notebook computer is being changed;

FIG. 10 is a schematic top view illustrating a portion of the switching module of the keyboard device according to the first embodiment of the present invention, in which the switching module is in a second status;

FIG. 11 is a schematic exploded view illustrating the keyboard device according to a second embodiment of the present invention;

FIG. 12 is a schematic top view illustrating a portion of the switching module of the keyboard device according to the third embodiment of the present invention, in which the switching module is in a first status; and

FIG. 13 is a schematic top view illustrating a portion of the switching module of the keyboard device according to the third embodiment of the present invention, in which the switching module is in a second status.

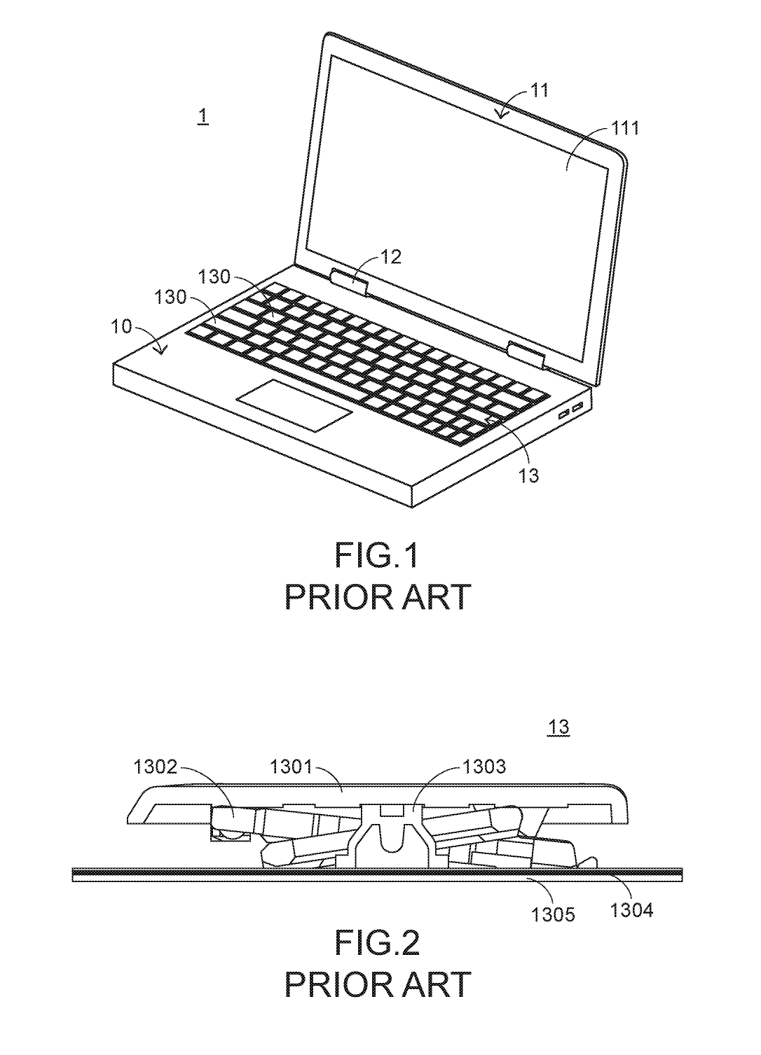

### DETAILED DESCRIPTION OF THE PREFERRED EMBODIMENT

For solving the drawbacks of the conventional technologies, the present invention provides a keyboard device having a function of avoiding erroneous operations.

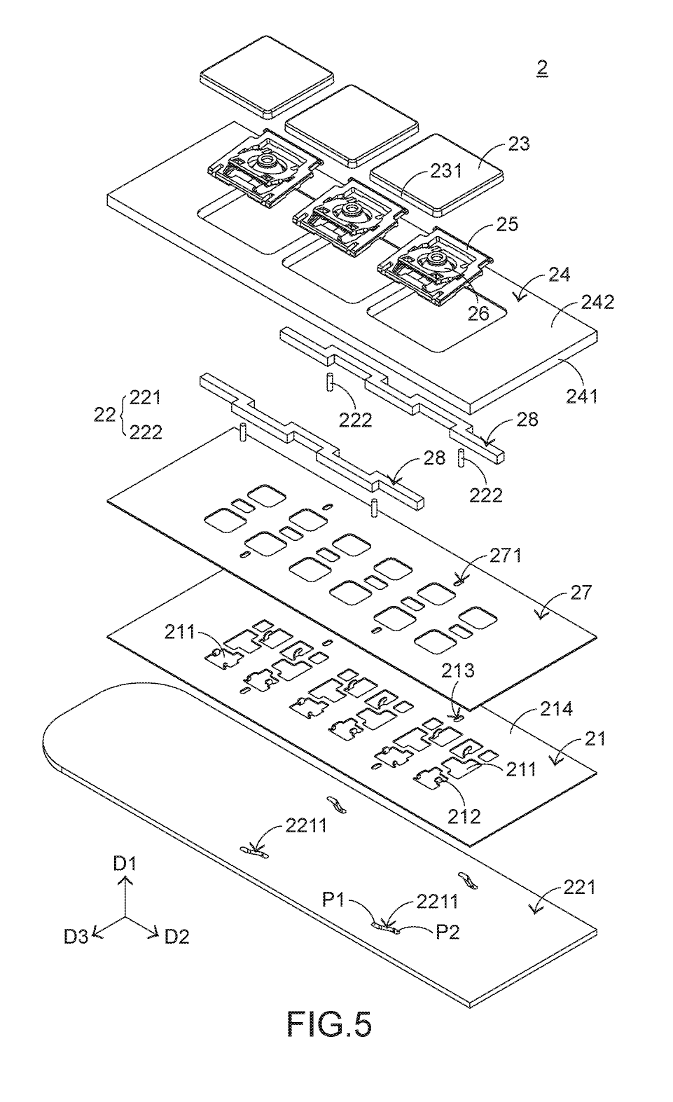

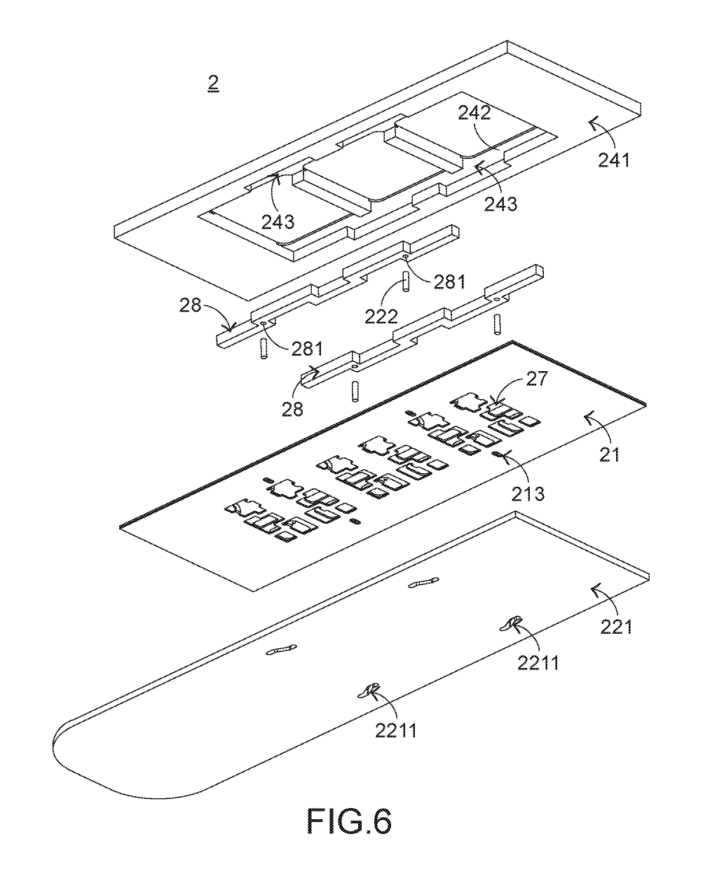

Please refer to FIGS. 4, 5 and 6. FIG. 4 is a schematic side cross-sectional view illustrating a notebook computer with a keyboard device according to a first embodiment of the present invention. FIG. 5 is a schematic exploded view illustrating the keyboard device according to the first embodiment of the present invention and taken along a viewpoint. FIG. 6 is a schematic exploded view illustrating the keyboard device according to the first embodiment of the present invention and taken along another viewpoint. All components of the keyboard device 2 can be seen in FIG. 5. In this embodiment, the keyboard device 2 comprises a supporting plate 21, a switching module 22, plural keycaps 23, a fixing frame 24, plural scissors-type connecting elements 25, plural elastic elements 26, a membrane switch circuit member 27 and plural stopping structures 28. The switching module 22 comprises a movable plate 221 and plural protrusion posts 222. The movable plate 221 of the keyboard device 2 is installed in a keyboard base 201 of a notebook computer 200. The keyboard base 201 is connected with a top cover 202. A rotary shaft 203 of the notebook computer 200 is connected with the top cover 202 and a transmission mechanism 204. The top cover 202 is rotatable relative to the keyboard base 201 through the rotary shaft 203. As the top cover 202 is rotated to different positions, the transmission mechanism 204 is enabled to allow the notebook computer 200 to be in different operation modes.

For example, in case that the top cover 202 is closed to cover the keyboard base 201, the notebook computer 200 is in a hibernation mode or a power-off mode. Whereas, in case that the top cover 202 is uplifted to expose the keyboard device 2 to the keyboard base 201, the notebook computer 200 is in a laptop mode. When the top cover 202 is inversely folded to be contacted with a rear surface of the keyboard base 201, the appearance of the notebook computer 200 is changed and the notebook computer 200 is in a tablet mode.

Please refer to FIGS. 5 and 6. The supporting plate 21 comprises plural supporting plate openings 211, plural supporting plate hooks 212 and plural first connecting holes 213. The plural supporting plate openings 211 and the plural first connecting holes 213 run through the supporting plate 21. The plural supporting plate openings 211 are located under the corresponding key caps 23. The plural first connecting holes 213 are aligned with the corresponding protrusion posts 222 of the switching module 22. The plural supporting plate hooks 214 of the supporting plate 21. The plural supporting plate hooks 214 are connected with the corresponding scissors-type connecting elements 25. The membrane switch circuit member 27 is disposed on the supporting plate 21. As the keycap 23 is moved to trigger the membrane switch circuit member 27, a key signal corresponding to the keycap 23 is generated. The membrane switch circuit member 27 comprises plural second connecting holes 271. The plural second connecting holes 271 run through the membrane switch circuit member 27. The second connecting holes 271 are aligned with the corresponding protrusion posts 222 of the switching module 22. The structures of the plural key interactions of the membrane switch circuit member 27 are similar to those of the conventional keyboard device, and are not redundantly described herein.

The keycap 23 is located over the supporting plate 21. As the keycap 23 is depressed by the user, the keycap 23 is moved relative to the supporting plate 21 in a first axial direction D1. Moreover, the keycap 23 comprises plural keycap hooks (not shown) corresponding to the scissors-type connecting elements 25. The plural elastic elements 26 is arranged between the keycap 23 and the membrane switch circuit member 27. When the elastic elements 26 are pushed by the corresponding keycaps 23, the membrane switch circuit member 27 is triggered by the corresponding elastic elements 26. In addition, the elastic elements 26 provide elastic forces to the corresponding keycaps 23. The scissors-type connecting elements 25 are arranged between the corresponding keycaps 23 and the membrane switch circuit member 27, and connected with the corresponding keycaps 23 and the supporting plate 21. The scissors-type connecting elements 25 are connected with the supporting plate 21 through the corresponding supporting plate hooks 212, and connected with the corresponding keycaps 23 through the corresponding keycap hooks. Consequently, the scissors-type connecting elements 25 are correspondingly moved with the corresponding keycaps 23. In an embodiment, the plural keycap hooks are integrally formed with the corresponding keycaps 23, and the elastic elements 26 are rubbery elastomers.

The plural stopping structures 28 are arranged between the supporting plate 21 and the keycaps 23 and located near the outer edges 231 of the keycaps 23. The stopping structures 28 comprise plural coupling recesses 281. The plural coupling recesses 281 are aligned with the corresponding protrusion posts 222. Moreover, the coupling recesses 281are formed in bottom surfaces of the stopping structures 28. The switching module 22 is located under the keycaps 23 and connected with the plural stopping structures 28. The switching module 22 is movable relative to the supporting plate 21 in a second axial direction D2. Consequently, the stopping structures 28 are moved with the switching module 22. The movable plate 221 of the switching module 22 is located under the supporting plate 21. Moreover, the movable plate 221 is movable relative to the supporting plate 21 in the second axial direction D2. The movable plate 221 comprises plural sliding tracks 2211. One protrusion post 222 is aligned with one sliding track 2211 and one stopping structure 28. The protrusion post 222 is inserted into the corresponding sliding track 2211. As the protrusion post 222 is pushed by the movable plate 221, the corresponding stopping structure 28 is moved relative to the supporting plate 21 in a third axial direction D3. Moreover, after the protrusion post 222 is inserted into the corresponding coupling recess 281, the protrusion post 222 and the corresponding stopping structure 28 are combined together.

As shown in FIGS. 5 and 6, the protrusion posts 222 are connected with the corresponding stopping structures 28. Moreover, the protrusion posts 222 are penetrated through the corresponding second connecting holes 271 and the corresponding first connecting holes 213 and inserted into the corresponding sliding tracks 2211. Consequently, the stopping structures 28 are connected with the switching module 22. In such way, the stopping structures 28 are moved with the switching module 22.

The fixing frame 24 is located over the supporting plate 21 and the membrane switch circuit member 27 and arranged around the keycaps 23. The fixing frame 24 comprises a frame body 241, a frame cover 242 and plural receiving parts 243. The frame body 241 is arranged around the keycaps 23. The receiving parts 243 are formed in inner walls of the frame body 241. The stopping structures 28 are received within the corresponding receiving parts 243. The frame body 241 and the receiving parts 243 are covered by the frame cover 242. In this embodiment, the frame body 241 and the frame cover 242 are integrally formed with each other.

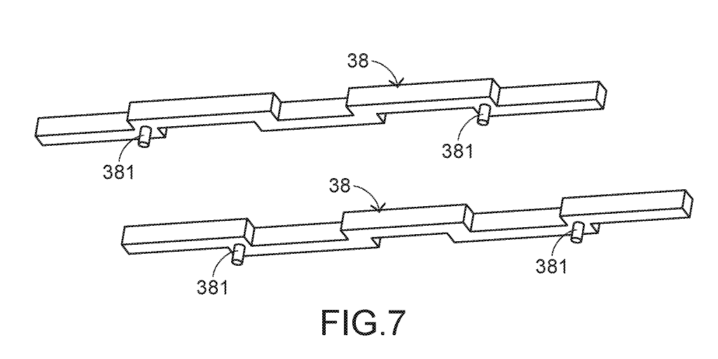

In the above embodiment, the protrusion posts 222 are connected with the corresponding stopping structures 28 through an assembling process. It is noted that the way of connecting the protrusion posts 222 with the corresponding stopping structures 28 is not restricted. For example, in another embodiment, the protrusion posts are connected with the corresponding stopping structures through adhering means or embedding means. Alternatively, the protrusion posts are integrally formed with the corresponding stopping structures. FIG. 7 is a schematic view illustrating the protrusion posts and the stopping structures of a keyboard device according to a second embodiment of the present invention. As shown in FIG. 7, the protrusion posts 381 are disposed on bottom surfaces of the stopping structures 38. Moreover, the protrusion posts 381 are integrally formed with the stopping structures 38.

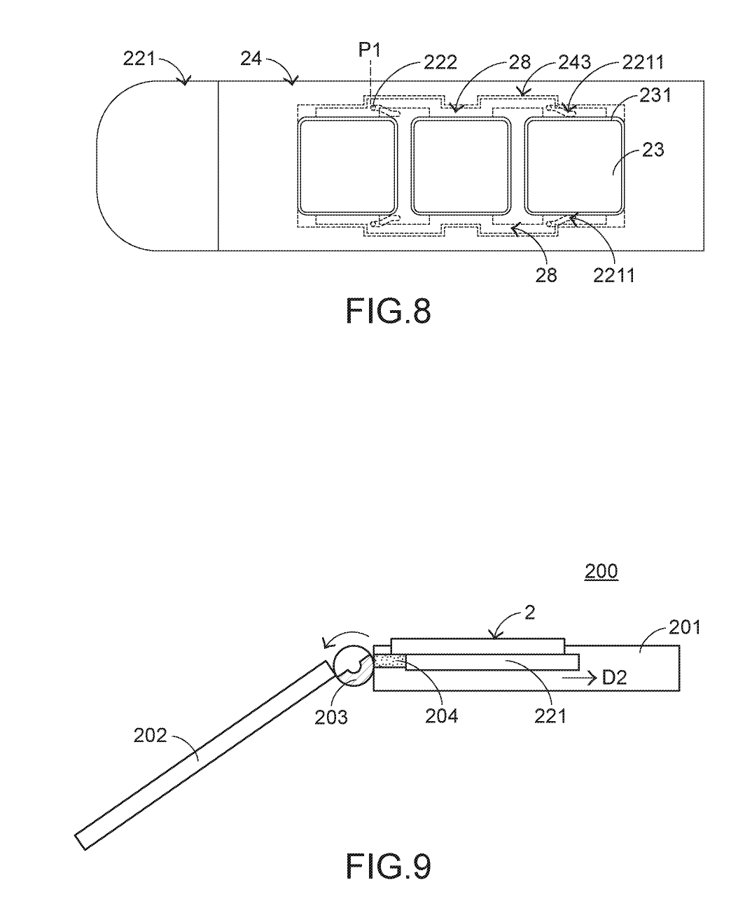

Please refer to FIGS. 5, 6 and 8. FIG. 8 is a schematic top view illustrating a portion of the switching module of the keyboard device according to the first embodiment of the present invention, in which the switching module is in a first status. In case that the switching module 22 is in the first status, the associated components of the keyboard device 2 can be seen in FIG. 8. When the switching module 22 is in the first status, the keycaps 23 of the keyboard device 22 can be depressed. Meanwhile, the protrusion posts 222 are located at the first positions P1 of the corresponding sliding tracks 2211, and the stopping structures 28 are received within the receiving parts 243.

When the switching module 22 is in the first status, the functions of the keys are enabled. While one of the keycaps 23 is depressed, the keycap 23 is moved downwardly in the first axial direction D1 in response to the depressing force and the scissors-type connecting element 25 is correspondingly swung. As the keycap 23 is moved downwardly to push the corresponding elastic element 26, the elastic element 26 is subjected to deformation to press the membrane switch circuit member 27 and trigger the corresponding key intersection (not shown) of the membrane switch circuit member 27. Consequently, the membrane switch circuit member 27 generates a corresponding key signal.

When the keycap 23 is no longer depressed by the user, no external force is applied to the keycap 23 and the elastic element 26 is no longer pushed by the keycap 23. In response to the elasticity of the elastic element 26, the elastic element 26 is restored to its original shape to provide an upward elastic restoring force to the keycap 23. As the keycap 23 is moved upwardly in the first axial direction D1, the scissors-type connecting element 25 is correspondingly swung. Consequently, the keycap 23 is returned to its original position where it is not depressed.

In the above embodiment, the elastic element 26 is a component of the keyboard device 2 for returning the keycap 23 to its original position. It is noted that the component for returning the keycap 23 to its original position is not restricted. For example, in another embodiment, the key structure further comprises two magnetic elements. One of the magnetic elements is installed on the keycap, and the other magnetic element is installed on the supporting plate or the membrane switch circuit member. While the keycap is depressed, the two magnetic elements interact with each other to generate a repulsive force. In response to the repulsive force, the keycap is moved upwardly and returned to its original position. However, in this case, a protrusion structure is additionally formed on an inner surface of the keycap to trigger the membrane switch circuit member.

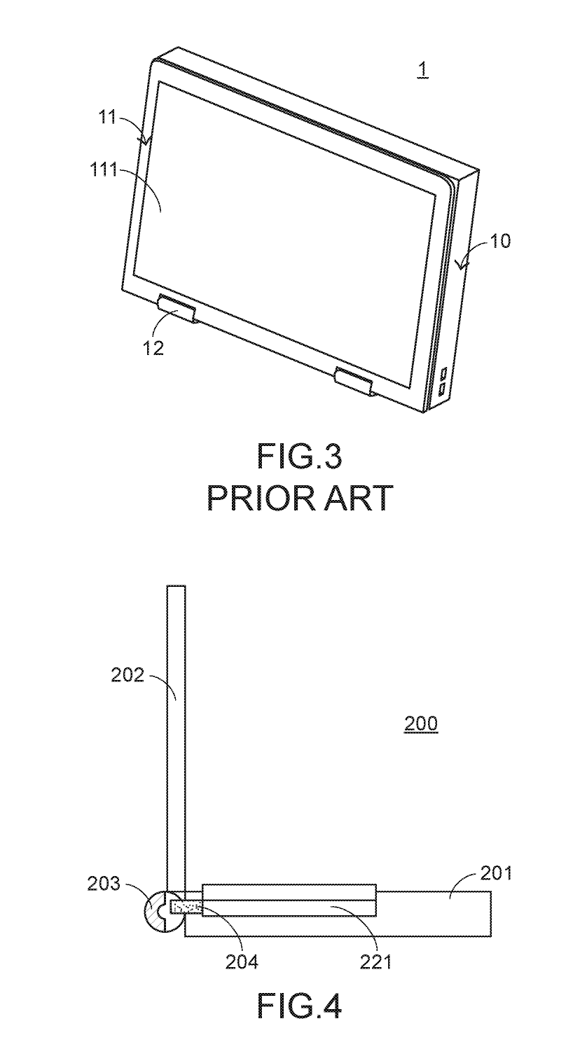

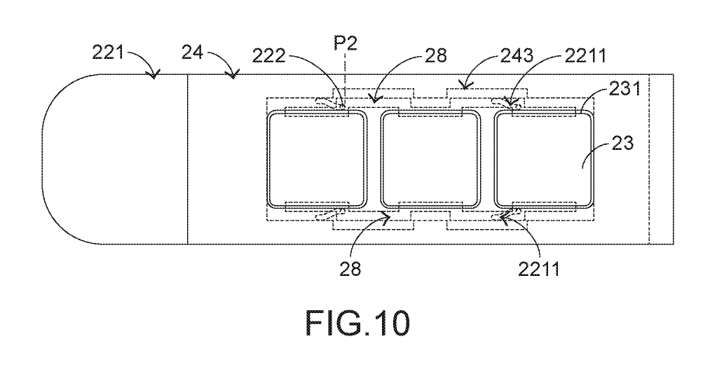

Hereinafter, a process of changing the appearance of the notebook computer 200 to switch the state of the keyboard device 2 will be illustrated with reference to FIGS. 4, 5, 6, 8, 9 and 10. FIG. 9 is a schematic side cross-sectional view illustrating the notebook computer with the keyboard device according to the first embodiment of the present invention, in which the appearance of the notebook computer is being changed. FIG. 10 is a schematic top view illustrating a portion of the switching module of the keyboard device according to the first embodiment of the present invention, in which the switching module is in a second status. As shown in FIG. 4, the transmission mechanism 204 is connected with the movable plate 221 of the switching module 22. Consequently, the transmission mechanism 204 and the movable plate 221 are linked with each other. For switching the operation mode of the notebook computer 200 from the laptop mode to the tablet mode (see FIG. 3), the top cover 202 is folded in a counterclockwise direction to allow the top cover 202 to be contacted with the rear surface of the keyboard base 201 (See FIG. 9). While the top cover 202 is folded in the counterclockwise direction, the rotary shaft 203 is rotated to push the transmission mechanism 204 and thus the transmission mechanism 204 is moved in the second axial direction D2 to push the movable plate 221. Consequently, the movable plate 221 is moved relative to the supporting plate 21 in the second axial direction D2.

While the movable plate 221 is moved in the second axial direction D2, the protrusion posts 222 in the corresponding sliding tracks 2211 are pushed by the movable plate 221. Consequently, the protrusion posts 222 are moved from the first positions P1 of the corresponding sliding tracks 2211 to the second positions P2 of the corresponding sliding tracks 2211. Since the stopping structures 28 are connected with the corresponding protrusion posts 222, the stopping structures 28 are moved with the corresponding protrusion posts 222. Consequently, the stopping structures 28 are escaped from the corresponding receiving parts 243 and moved relative to the supporting plate 21 in the third axial direction D3. Under this circumstance, the stopping structures 28 are moved to the positions under the outer edges 231 of the keycaps 23 in order to stop movement of the keycaps 23 in the first axial direction D1. Meanwhile, the notebook computer 200 is in a tablet mode, and the switching module 22 is in the second status. As shown in FIG. 10, the stopping structures 28 are located under the outer edges 231 of the keycaps 23.

Due to the action of the switching module 22, the keycaps 23 cannot be moved in the first axial direction D1. That is, when the notebook computer 200 is in the tablet mode, the keycaps 23 are stopped from being descended by the stopping structures 28. Even if the keycap 23 is depressed by the user at this moment, the keycap 23 is not moved downwardly. As a consequence, the problem of causing erroneous operation is avoided.

For switching the operation mode of the notebook computer 200 from the tablet mode to the laptop mode, the rotary shaft 203 is rotated to push the transmission mechanism 204. Consequently, the transmission mechanism 204 is moved in an opposite direction to push the movable plate 221, and the movable plate 221 is moved relative to the supporting plate 21 in the second axial direction D2. While the movable plate 221 is moved in the second axial direction D2, the protrusion posts 222 are moved from the second positions P2 of the corresponding sliding tracks 2211 to the first positions P1 of the corresponding sliding tracks 2211. Moreover, as the stopping structures 28 are moved with the corresponding protrusion posts 222, the stopping structures 28 are moved relative to the supporting plate 21 in the third axial direction D3 and received within the corresponding receiving parts 243.

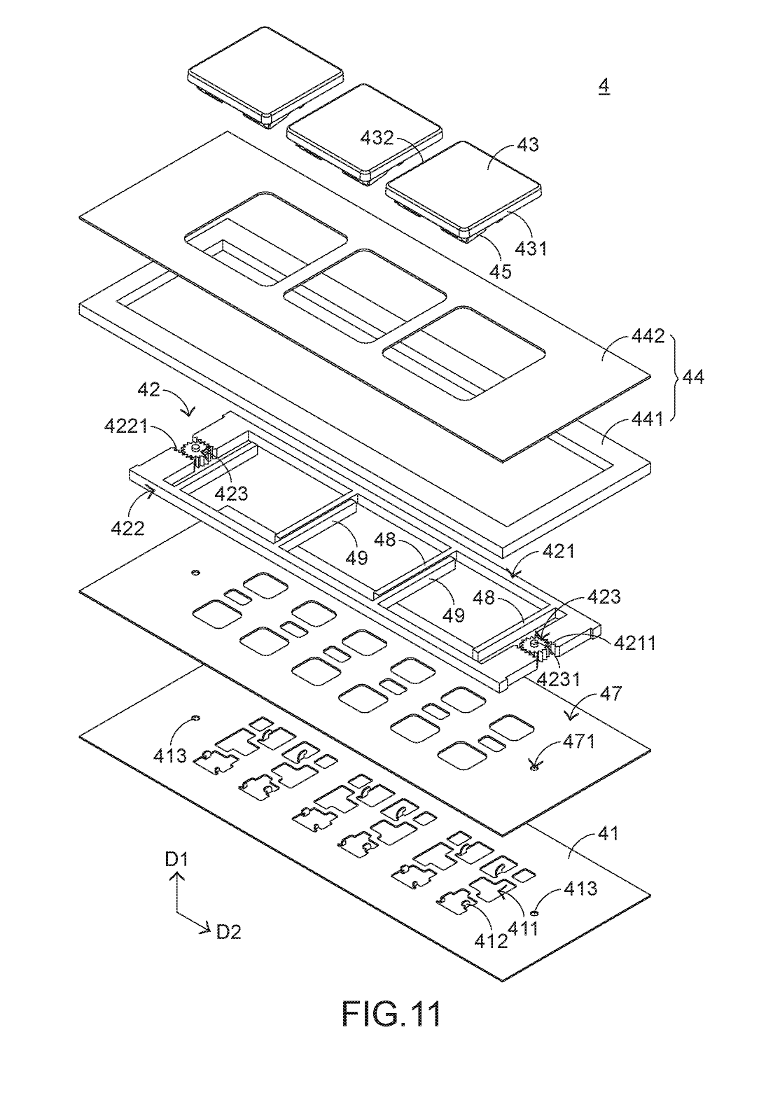

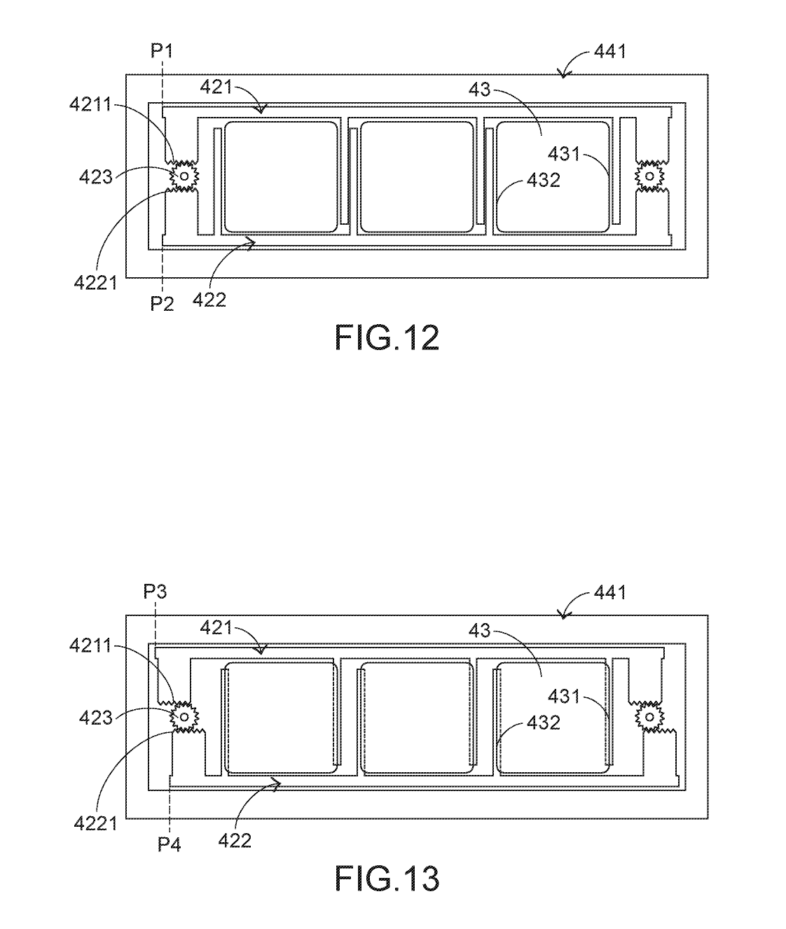

The present invention further provides a third embodiment, which is distinguished from the above embodiments. Please refer to FIGS. 11, 12 and 13. FIG. 11 is a schematic exploded view illustrating the keyboard device according to a second embodiment of the present invention. FIG. 12 is a schematic top view illustrating a portion of the switching module of the keyboard device according to the third embodiment of the present invention, in which the switching module is in a first status. FIG. 13 is a schematic top view illustrating a portion of the switching module of the keyboard device according to the third embodiment of the present invention, in which the switching module is in a second status. In this embodiment, the keyboard device 4 comprises a supporting plate 41, a switching module 42, plural keycaps 43, a fixing frame 44, plural scissors-type connecting elements 45, plural elastic elements (not shown), a membrane switch circuit member 47, plural first stopping structures 48 and plural second stopping structures 49. The switching module 42 is connected with a transmission mechanism (not shown) of a notebook computer (not shown). The supporting plate 41 comprises plural supporting plate openings 411, plural supporting plate hooks 412 and plural first connecting holes 413. The membrane switch circuit member 47 comprises plural second connecting holes 471. The plural first stopping structures 48 are arranged between the supporting plate 41 and the keycaps 43 and located near the first outer edges 431 of the keycaps 43. The plural second stopping structures 49 are arranged between the supporting plate 41 and the keycaps 43 and located near the second outer edges 432 of the keycaps 43. The structures and functions of the components of the key structure 4 which are identical to those of the above embodiments are not redundantly described herein. In comparison with the above embodiments, the key structure 4 of this embodiment has two distinguished aspects. Firstly, the structure of the switching module 42 is distinguished. Secondly, the structure of the fixing frame 44 is distinguished.

The structure of the switching module 42 will be described as follows. The switching module 42 comprises a first movable plate 421, a second movable plate 422 and plural gears 423. The first movable plate 421 is located over the membrane switch circuit member 47 and arranged beside the first sides of the keycaps 423. The first movable plate 421 is connected with the plural first stopping structures 48 and movable relative to the supporting plate 41 in the second axial direction D2. Moreover, the first movable plate 421 comprises plural first racks 4211. Similarly, the second movable plate 422 is arranged beside the second sides of the keycaps 423. The second movable plate 422 is connected with the plural second stopping structures 49 and movable relative to the supporting plate 41 in the second axial direction D2. Moreover, the second movable plate 422 comprises plural second racks 4221. The plural gears 423 are arranged between the first movable plate 421 and the second movable plate 422 and engaged with the corresponding first racks 4211 and the corresponding second racks 4221. Each gear 423 comprises a fixing shaft 4231. After the fixing shaft 4231 is penetrated through the corresponding second connecting hole 471 and the corresponding first connecting hole 413, the fixing shaft 4231 is fixed on the membrane switch circuit member 47 and the supporting plate 41.

In an embodiment, only one of the first movable plate 421 and the second movable plate 422 of the switching module 42 is connected with the transmission mechanism of the notebook computer. For example, the first movable plate 421 is connected with the transmission mechanism. When the transmission mechanism is enabled, the first movable plate 421 is moved relative to the supporting plate 41 in the second axial direction D2. Since the plural gears 423 are engaged with the corresponding first racks 4211 and the corresponding second racks 4221, the second movable plate 422 is moved relative to the supporting plate 41 in the second axial direction D2. However, the moving direction of the second movable plate 422 is opposite to the moving direction of the first movable plate 421. Alternatively, the second movable plate is connected with the transmission mechanism.

The structure of the fixing frame 44 will be described as follows. The fixing frame 44 is located over the supporting plate 41 and the membrane switch circuit member 47 and arranged around the keycaps 43. The fixing frame 44 comprises a frame body 441 and a frame cover 442. The frame body 441 is arranged around the keycaps 43. The volume of the frame body 441 is smaller than the volume of the frame body 241 of the above embodiment. The frame cover 442 is placed on the frame body 441 to cover the frame body 441. Consequently, an accommodation space is formed between the frame cover 442 and the frame body 441. The first movable plate 421, the second movable plate 422, the plural gears 423, the plural first stopping structures 48 and the plural second stopping structures 49 are received within the accommodation space. It is noted that the way of coupling the frame body 441 with the frame cover 442 is not restricted. Since the frame body 441 and the frame cover 442 are separate components, the plural keycaps 43, the fixing frame 44, the plural scissors-type connecting elements 45, the plural elastic elements, the first movable plate 421, the second movable plate 422 and the plural gears 423 can be assembled more easily.

In case that the switching module 42 is in the first status, the associated components of the keyboard device 4 can be seen in FIG. 11. When the switching module 42 is in the first status, the keycaps 43 of the keyboard device 42 can be depressed. While one of the keycaps 43 is depressed, the keycap 43 is moved downwardly in the first axial direction D1. Meanwhile, the first movable plate 421 is located at a first position P1, and the second movable plate 422 is located at a second position P2. Consequently, the plural first stopping structures 48 are located near the first outer edges 431 of the keycaps 43, and the plural second stopping structures 49 are located near the second outer edges 432 of the keycaps 43.

Please refer to FIGS. 11, 12 and 13 again. For switching the notebook computer to be in the tablet mode, the transmission mechanism is enabled and the first movable plate 421 is moved relative to the supporting plate 41 in the second axial direction D2. Since the plural gears 423 are engaged with the corresponding first racks 4211 and the corresponding second racks 4221, the second movable plate 422 is moved relative to the supporting plate 41 in the second axial direction D2. However, the moving direction of the second movable plate 422 is opposite to the moving direction of the first movable plate 421. As the first stopping structures 48 are moved with the first movable plate 421 and the second stopping structures 49 are moved with the second movable plate 422, the first stopping structures 48 are moved to the positions under the first outer edges 431 of the keycaps 43, and the second stopping structures 49 are moved to the positions under the second outer edges 432 of the keycaps 43. That is, the first movable plate 421 is moved from the first position P1 to a third position P3 and the second movable plate 422 is moved from the second position P2 to a fourth position P4. Consequently, the keycaps 43 are stopped from being moved in the first axial direction D1. Under this circumstance, the notebook computer is in the tablet mode, and the switching module 42 is in the second status (see FIG. 13). In other words, the first stopping structures 48 and the second stopping structures 49 are moved to stop the keycaps 43 through the switching module 42 of the keyboard device 4.

For switching the operation mode of the notebook computer from the tablet mode to the laptop mode, the first movable plate 421 is moved in an opposite direction through the transmission mechanism. The moving direction of the second movable plate 422 is opposite to the moving direction of the first movable plate 421. Consequently, the first movable plate 421 is returned to the first position P1, and the second movable plate 422 is returned to the second position P2. The plural first stopping structures 48 are returned to the positions near the first outer edges 431 of the keycaps 43, and the plural second stopping structures 49 are returned to the positions near the second outer edges 432 of the keycaps 43 (see FIG. 11).

From the above descriptions, the present invention provides the keyboard device. As the movable plate of the switching module is moved, the stopping structures are correspondingly moved. Consequently, the keycaps are selectively in a depressible mode or a non-depressible mode. When the notebook computer is in the tablet mode, even if the keycap is carelessly touched, the problem of causing erroneous operation is avoided. In a preferred embodiment, the function of the membrane switch circuit member is disabled through a software control method when the notebook computer is in the tablet mode. Since the membrane switch circuit member is not triggered, the possibility of causing the erroneous operation is further avoided. In comparison with the conventional technologies, the keyboard device of the present invention has simpler structure and is easily operated. Consequently, the keyboard device of the present invention can solve the drawbacks of the conventional technologies.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A keyboard device, comprising:
a supporting plate;
a keycap located over the supporting plate, and movable relative to the supporting plate in a first axial direction;
a first stopping structure arranged between the supporting plate and the keycap, and located near a first outer edge of the keycap; and
a switching module located under the keycap and connected with the first stopping structure, wherein while the switching module is moved relative to the supporting plate in a second axial direction, the first stopping structure is correspondingly moved, wherein when the switching module is in a first status, the first stopping structure is located near the first outer edge of the keycap, wherein when the switching module is in a second status, the first stopping structure is moved to a position under the first outer edge of the keycap, so that the keycap is not allowed to be moved in the first axial direction.

2. The keyboard device according to claim 1, wherein the switching module comprises:
a movable plate located under the supporting plate, and movable relative to the supporting plate in the second axial direction, wherein the movable plate comprises a sliding track; and
a protrusion post inserted into the sliding track, wherein when the protrusion post is pushed by the movable plate, the first stopping structure is correspondingly moved relative to the supporting plate in a third axial direction, wherein when the switching module is in the first status, the protrusion post is located at a first position of the sliding track and the keycap is moved relative to the supporting plate in the first axial direction in response to a depressing action, wherein when the switching module is in the second status, the movable plate is moved to push the protrusion post, so that the protrusion post is moved to a second position of the sliding track, wherein when the protrusion post is moved to the second position of the sliding track, the first stopping structure is correspondingly moved to a position under the first outer edge of the keycap and the keycap is not allowed to be moved in the first axial direction.

3. The keyboard device according to claim 2, wherein the first stopping structure comprises a coupling recess, and the coupling recess is formed in a bottom surface of the first stopping structure, wherein the protrusion post is inserted into the coupling recess, so that the protrusion post is connected with the first stopping structure.

4. The keyboard device according to claim 2, wherein the protrusion post is formed on a bottom surface of the first stopping structure, and the protrusion post is integrally formed with the first stopping structure.

5. The keyboard device according to claim 2, further comprising:
a membrane switch circuit member located over the supporting plate, wherein as the keycap is moved, a key signal corresponding to the keycap is generated by the membrane switch circuit member;
a scissors-type connecting element connected with the keycap and the supporting plate, wherein the keycap is fixed on the supporting plate through the scissors-type connecting element; and
an elastic element arranged between the keycap and the membrane switch circuit member, wherein when the elastic element is pushed by the keycap, the membrane switch circuit member is triggered by the elastic element, wherein when the keycap is no longer depressed, the elastic element provides an elastic force to the keycap, the keycap is moved in response to the elastic force, and the scissors-type connecting element is correspondingly swung.

6. The keyboard device according to claim 5, wherein the supporting plate comprises a first connecting hole, and the membrane switch circuit member comprises a second connecting hole, wherein the protrusion post is sequentially penetrated through the second connecting hole and the first connecting hole and inserted into the sliding track.

7. The keyboard device according to claim 1, wherein the keyboard further comprises a second stopping structure, wherein the second stopping structure is arranged between the supporting plate and the keycap, and located near a second outer edge of the keycap, wherein the switching module comprises:
a first movable plate arranged beside a first side of the keycap and connected with the first stopping structure, wherein the first movable plate is movable relative to the supporting plate in the second axial direction, and the first movable plate comprises a first rack;
a second movable plate arranged beside a second side of the keycap and connected with the second stopping structure, wherein the second movable plate is movable relative to the supporting plate in the second axial direction, and the second movable plate comprises a second rack; and
a gear arranged between the first movable plate and the second movable plate, and engaged with the first rack and the second rack.

8. The keyboard device according to claim 7, wherein when the switching module is in the first status, the first movable plate is located at a first position, the second movable plate is located at a second position, and the keycap is movable relative to the supporting plate in the first axial direction in response to the depressing action, wherein when the first movable plate is moved to a third position and the second movable plate is moved to a fourth position, the first stopping structure is moved with the first movable plate and moved to a position under the first outer edge of the keycap, and the second stopping structure is moved with the second movable plate and moved to a position under the second outer edge of the keycap, so that the keycap is not allowed to be moved in the first axial direction.

9. The keyboard device according to claim 1, wherein the keyboard device further comprises a fixing frame, wherein the fixing frame is located over the supporting plate and arranged around the keycap, and the fixing frame comprises a receiving part for receiving the first stopping structure, wherein when the switching module is in the first status, the first stopping structure is received within the receiving part, wherein when the switching module is in the second status, the first stopping structure is moved with the switching module, escaped from the receiving part, and moved to a position under the first outer edge of the keycap.

10. The keyboard device according to claim 9, wherein the fixing frame further comprises:
a frame body arranged around the keycap, wherein the receiving part is formed in an inner wall of the frame body; and
a frame cover, wherein the frame body and the receiving part are covered by the frame cover.
